(19) United States
(12) Patent Application Publication
(10) Pub. No.: US 2017/0242742 A1
(43) Pub. Date: Aug. 24, 2017

(54) DATA PROCESSING DEVICE, CONTROL METHOD FOR DATA PROCESSING DEVICE, AND STORAGE MEDIUM

(71) Applicant: CANON KABUSHIKI KAISHA, Tokyo (JP)

(72) Inventor: Tomohiro Akiba, Tokyo (JP)

(21) Appl. No.: 15/435,059

(22) Filed: Feb. 16, 2017

(30) Foreign Application Priority Data
Feb. 19, 2016 (JP) 2016-030171

(51) Int. Cl. G06F 11/07; G06F 21/60

(52) U.S. Cl. CPC G06F 11/0733; G06F 21/602; G06F 11/0751; G06F 11/0787; G06F 11/0793

(57) ABSTRACT

According to one embodiment, in a case where a test on an encryption device indicates an error in an encryption process of the encryption device, a data processing device holds a result of the test on the encryption device in a holding unit, and notifies that the encryption device has an error on the basis of the result of the test on the encryption device.

### BACKGROUND

### Field

The present disclosure relates to a data processing device, a control method for the data processing device, and a storage medium.

### Description of the Related Art

A data processing device can include a hard disk drive (HDD) as a storage device. A technology has been proposed in which an encryption unit is connected between an HDD controller and such an HDD so that data stored in the HDD can be encrypted/decrypted.

Federal Information Processing Standards (FIPS) 140-2 exist which define security requirements regarding an encryption unit and international standards IEEE Std 2600™-2008 (hereinafter, IEEE2600) for multi function peripherals and printers, for example. One of the requirements provided in such standards is a self-test for an encryption unit to determine whether a security function of the encryption unit is normally running on the encryption unit or not.

To meet this requirement, an encryption unit can have an internal self-test function. A data processing device can check whether encryption processing is operating in accordance with specifications, whether encryption processing has been tampered with or not, and so on, by reviewing a result of a self-test performed by the encryption unit.

Japanese Patent Laid-Open No. 2012-194964 discloses an information processing device which performs a self-test on HDD encryption function to determine whether a security function of an encryption process is operating normally in the information processing device or not. If running a self-test on the HDD encryption function produces a result which shows the encryption function is successfully operating, the information processing device boots the HDD encryption function. On the other hand, if running the self-test on the HDD encryption function produces a result which shows a failure of the encryption function, the information processing device stops booting of functions associated with the HDD encryption function.

This is because, if running the self-test on the encryption unit produces a result which shows a failure of the encryption function, there is a possibility that data stored in the HDD may not be encrypted correctly by the encryption unit. In a case where data stored in the HDD is not encrypted correctly and when the data stored in the HDD may be exploited by a third party, there is a risk that the data stored in the HDD may be accessed without permission. In order to avoid this outcome, the encryption unit may block an acquisition request for data stored in the HDD where the self-test on the encryption unit returns a result which indicates a failure of the encryption function.

On the other hand, upon booting of a data processing device or connection to an HDD, the data processing device typically determines whether the HDD connected to the data processing device is available for data acquisition requests or not on the basis of basic information (including the storage capacity, the model and the used time) regarding the HDD. However, in the above system, if the self-test on the encryption unit produces a result which indicates a failure of the encryption unit, an acquisition request for the data stored in the HDD may be blocked, as described above. Thus the self-test of the encryption function can have an unsuccessful result even where the data processing device can acquire basic information (including the storage capacity, the model and the used time) of the HDD connected to the device. Therefore, whether the HDD connected to the device is available for data acquisition requests or not may be difficult to determine. When the basic information regarding the HDD may not be acquired, the data processing device recognizes that the HDD is not connected to the device. Thus, when this occurs, the data processing device will not issue an acquisition request for information regarding the HDD or information regarding the encryption unit. Because information (including information whether running the self-test results in an indication of encryption unit failure) regarding the encryption unit is not acquired by the data processing device, a user cannot determine that the data stored in the HDD cannot be acquired because the encryption unit is in an error state.

### SUMMARY

Various embodiments provide a device and a method by which, when a test performed on an encryption device generates a result which indicates an error in an encryption process of the encryption device, a user can determine that data stored in a storage device cannot be acquired because the encryption device is in an error state.

According to various embodiments, a data processing device is provided which includes a storage that stores data, an encryption unit that encrypts data to be stored in the storage, a memory that stores a set of instructions, and at least one processor that executes the instructions to: acquire information stored in the storage via the encryption unit; perform control so as to acquire the information stored in the storage in a case where a test performed by the encryption unit produces a result indicating a failure in an encryption process; hold the result of the test performed by the encryption unit in a holding unit in a case where the test performed by the encryption unit produces the result indicating a failure in an encryption process, and notify information indicating that the test performed by the encryption unit indicates a failure in an encryption process on the basis of the result of the test performed by the encryption unit.

Further features will become apparent from the following description of exemplary embodiments with reference to the attached drawings.

### BRIEF DESCRIPTION OF THE DRAWINGS

FIG. 1 is a block diagram illustrating a configuration of an MFP according to a first embodiment.

FIG. 2 is a block diagram illustrating a configuration of an encryption unit according to the first embodiment.

FIG. 3 is a sequence diagram illustrating a flow of processing according to the first embodiment.

FIG. 4 is a schematic diagram illustrating a configuration of a screen according to the first embodiment.

FIG. 5 is a sequence diagram illustrating a flow of processing according to a second embodiment.

FIG. 6 is a sequence diagram illustrating a flow of processing according to a third embodiment.

FIG. 7 is a sequence diagram illustrating a flow of processing according to a fourth embodiment.

### DESCRIPTION OF THE EMBODIMENTS

Embodiments will be described in detail below with reference to attached drawings. However, it is not intended for the embodiments described below to limit the claimed invention. All of combinations of features according to the described embodiments are not required for implementation of other embodiments of the present disclosure.

### First Embodiment

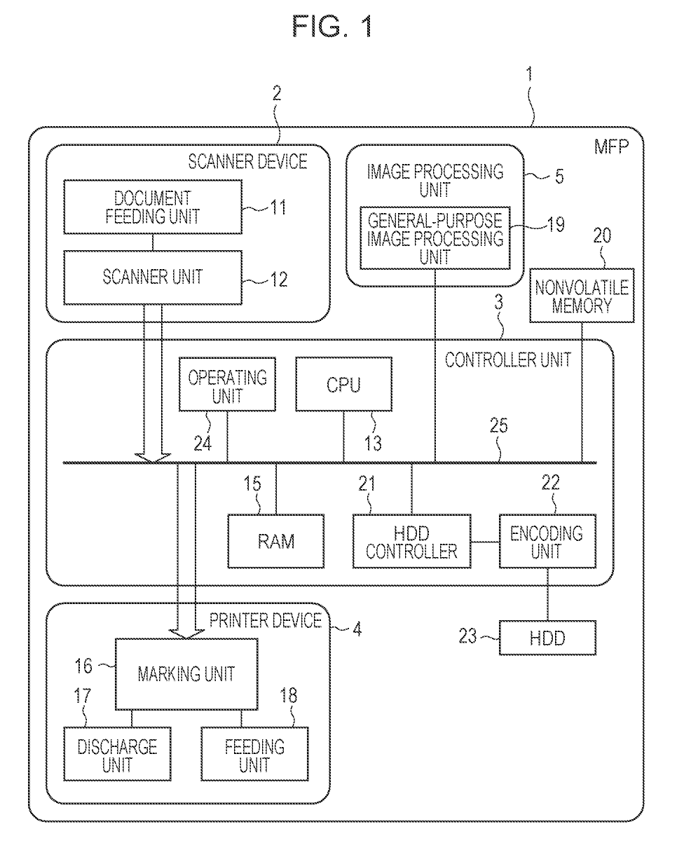

A configuration of an MFP (Multi Function Peripheral) according to a first embodiment will be described with reference to a block diagram illustrated in FIG. 1.

An MFP 1 being an example of a data processing device according to the first embodiment includes a scanner device 2 being an image input device, a printer device 4 being an image output device, an image processing unit 5, a nonvolatile memory 20, a hard disk drive (HDD) 23 being a storage device, and a controller unit 3.

The scanner device 2 has a document feeding unit 11 and a scanner unit 12. These units are electrically connected and mutually exchange control commands and data.

The document feeding unit 11 has a document tray on which a document is to be mounted to convey the document mounted on the document tray. In order to read a document conveyed by the document feeding unit 11, the scanner unit 12 may optically read image information printed on the conveyed document at a position of a fixed optical system. On the other hand, in order to read a document mounted on a platen glass, the scanner unit 12 may scan an optical system in a sub scanning direction with respect to the document mounted on the platen glass to optically read image information printed on the document mounted on the platen glass. Image information read by the optical system such as a CCD sensor is photoelectrically converted and is input as image data to the controller unit 3.

The printer device 4 performs an operation (print operation) for outputting an image to a sheet on the basis of the image data transferred to the printer device 4. The printer device 4 has a feeding unit 18, a marking unit 16, and a discharge unit 17. These units are electrically connected and mutually exchange control commands and data.

The feeding unit 18 has a plurality of cassettes and a manual feed tray for storing sheets to be used for printing and conveys a sheet stored in one of the cassettes or the manual feed tray to the marking unit 16. The marking unit 16 is configured to transfer and fix toner (developing agent) image formed on the basis of image data to a sheet or sheets conveyed by the feeding unit 18 and form (print) the corresponding image to the sheet or sheets. The discharge unit 17 is configured to externally discharge the sheet or sheets having the image formed by the marking unit 16.

The controller unit 3 has a CPU 13, a RAM 15, an HDD controller 21, an encryption unit 22, and an operation unit 24. These units are electrically connected via a system bus 25 and mutually exchange control commands and data. Although an example will be described below in which the encryption unit 22 is implemented by a hardware chip according to this embodiment, other embodiments may not include this feature. The encryption unit 22 may be implemented by a program executed by the CPU 13. In other words, the encryption unit 22 may also be implemented by software.

The CPU 13 may generally control the MFP 1 on the basis of a control program stored in the RAM 15. The CPU 13 may read out a control program stored in the RAM 15 and execute control processing such as control over reading by the scanner device 2, control over printing by the printer device 4, and control over updating of a firmware program.

The CPU 13 may temporarily store image data received from the scanner device 2 in the RAM 15. The CPU 13 may store image data temporarily stored in the RAM 15 to the HDD 23.

The CPU 13 may read out image data stored in the HDD 23 and temporarily store them in the RAM 15. The CPU 13 may then transfer image data temporarily stored in the RAM 15 to the printer device 4.

The image processing unit 5 has a general-purpose image processing unit 19 and is configured to perform image processing such as enlargement, reduction, and rotation of an image. The general-purpose image processing unit 19 may perform processing such as reduction on image data stored in the RAM 15 and can store the image data after the reduction back to the RAM 15.

The nonvolatile memory 20 is an example of a holding unit. The nonvolatile memory 20 is configured to store setting information required by the controller unit 3 for operating. The nonvolatile memory 20 is capable of holding data even when the MFP 1 is powered off.

The RAM 15 is an example of a holding unit. The RAM 15 is a memory to and from which data can be written and read out. The RAM 15 is configured to store image data transferred from the scanner device 2, a program, and setting information.

The HDD 23 is an example of a storage device. The HDD 23 is configured to store a control program, image data, a user database storing user information such as user IDs and passwords, a document database storing document data of a personal document, for example, and a held job. The HDD 23 may store a media library storing media information such as names, surface properties and grammage of sheets to be usable for printing. The HDD 23 is connected to the controller unit 3 through the HDD controller 21 and the encryption unit 22.

The HDD controller 21 is an example of a storage control device. The HDD controller 21 converts a command received from the CPU 13 to an electric signal interpretable by the HDD 23 and transfers the command to the encryption unit 22. The HDD controller 21 converts an electric signal received from the HDD 23 to a command interpretable by the CPU 13 and transfers the command to the CPU 13. For example, the HDD controller 21 may transfer data stored in the HDD 23 to the encryption unit 22. For example, the HDD controller 21 transfers acquisition request for basic information (including the storage capacity, the model and the used time) regarding the HDD 23 (hereinafter HDD information acquisition request) to the encryption unit 22.

The encryption unit 22 is an encryption chip connectable between the HDD controller 21 and the HDD 23. The encryption unit 22 is configured to encrypt data transferred from the HDD controller 21 and transfer the encrypted data to the HDD 23. Thus, the data encrypted by the encryption unit 22 are stored in the HDD 23. The encryption unit 22 is further configured to decrypt data stored in the HDD 23 and transfer the decrypted data to the HDD controller 21.

The operation unit 24 is an example of a user interface unit and has a display unit and a key input unit. The operation unit 24 is configured to receive a setting from a user through the display unit and the key input unit. The operation unit 24 is configured to cause the display unit to display information to be notified to a user. The display unit may be configured to display an operation screen for the MFP 1, a state of the encryption unit 22, a state of the HDD 23 and so on.

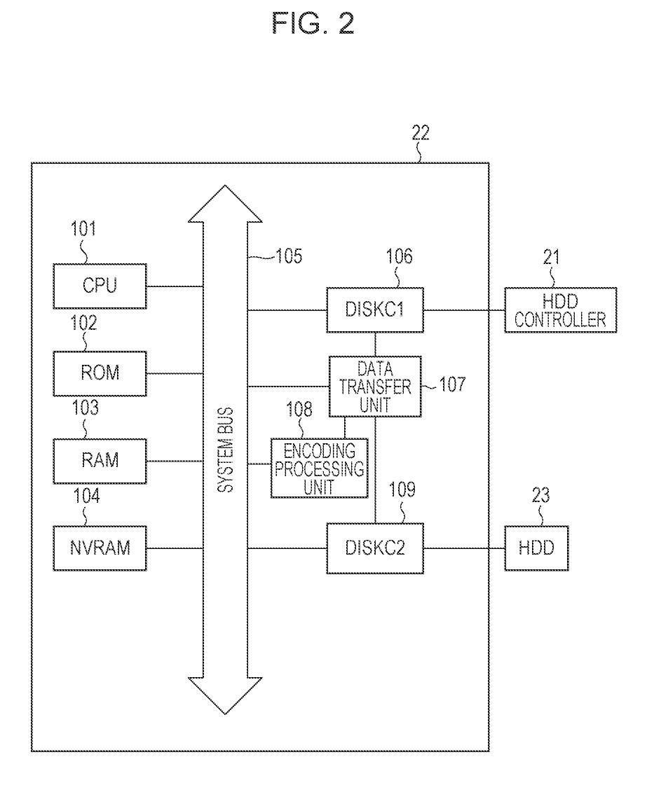

Next, a configuration of the encryption unit 22 will be described with reference to the block diagram in FIG. 2.

The encryption unit 22 includes a CPU 101, a ROM 102, a RAM 103, a NVRAM 104, a disk controller 1 (DISKC1) 106, a data transferring unit 107, an encryption processing unit 108, and a disk controller 2 (DISKC2) 109. These units are electrically connected through a system bus 105 and mutually exchange control commands and data.

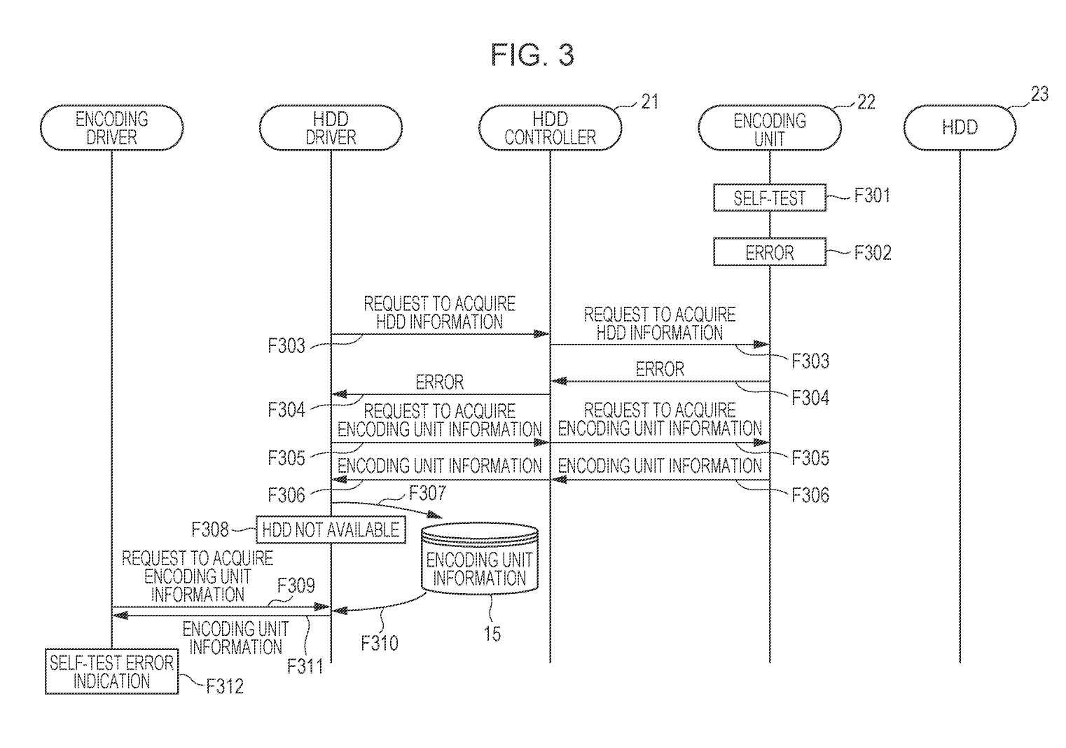

The CPU 101 may generally control the encryption unit 22 on the basis of a control program stored in the ROM 102 or the RAM 103. For example, the CPU 101 transmits to the HDD controller 21 a command that instructs a predetermined process (such as an acquisition request for the storage capacity, the model and the used time of the HDD 23) to the HDD 23 on the basis of a control program stored in the ROM 102 or the RAM 103. For example, the CPU 101 performs a self-test on the encryption unit 22 on the basis of a control program stored in the ROM 102 or the RAM 103. The self-test on the encryption unit 22 is a function related to IEEE2600 and includes a test relating to encryption processing in the HDD 23. Details of the self-test on the encryption unit 22 will be described below with reference to FIG. 3.

The ROM 102 or the RAM 103 holds an encryption driver that is a program for controlling the encryption unit 22. The ROM 102 or the RAM 103 holds an HDD driver that is a program for controlling the HDD controller 21.

The ROM 102 holds data for calculating known solutions usable for comparisons with calculated values as a result of calculations in the self-test in the encryption unit 22 and for calculating a test checksum.

The NVRAM 104 holds information such as settings required by the encryption unit 22 for operating and a state of the encryption unit 22 (including an execution result of a self-test on the encryption unit 22). The information stored in the NVRAM 104 is held even when the encryption unit 22 is powered off.

The disk controller 1 (DISKC1) 106 is electrically connected to the HDD controller 21 through a SATA cable and mutually exchanges a control command and data with the HDD controller 21. The disk controller 2 (DISKC2) 109 is electrically connected to the HDD 23 through a SATA cable and mutually exchange control commands and data with the HDD 23.

The encryption processing unit 108 is configured to encrypt data. The encryption processing unit 108 is further configured to decrypt encrypted data.

The data transferring unit 107 is electrically connected to the encryption processing unit 108, the disk controller 1 (DISKC1) 106, and the disk controller 2 (DISKC2) 109 and mutually exchange control commands and data with them.

Data that are not encrypted (hereinafter, called non-encrypted data) and stored in the HDD 23 are input to the encryption processing unit 108 through the disk controller 2 (DISKC2) 109. Non-encrypted data input to the encryption processing unit 108 are encrypted by the encryption processing unit 108. Subsequently, the data transferring unit 107 transfers data encrypted by the encryption processing unit 108 (hereinafter, called encrypted data) to the disk controller 2 (DISKC2) 109. The encrypted data transferred to the disk controller 2 (DISKC2) 109 are input to the HDD 23.

On the other hand, encrypted data stored in the HDD 23 are input to the encryption processing unit 108 through the disk controller 2 (DISKC2) 109. The encrypted data input to the encryption processing unit 108 are decrypted by the encryption processing unit 108. Subsequently, the data transferring unit 107 transfers data decrypted by the encryption processing unit 108 (hereinafter, called decrypted data) to the disk controller 1 (DISKC1) 106. Then, the decrypted data transferred to the disk controller (DISKC1) 106 are input to the HDD controller 21.

Next, flows of processing in the HDD controller 21, the encryption unit 22, and the HDD 23 will be described with reference to the sequence diagram in FIG. 3. This control program includes an encryption driver and an HDD driver and runs on the CPU 13. Functions of the encryption driver may be implemented by a program (software of the encryption driver) executed by the CPU 13. Functions of the HDD may be implemented by a program (software of the HDD driver) executed by the driver CPU 13. The encryption driver belongs to a higher layer of the HDD driver. Thus, functions of the encryption driver depend on functions of the HDD driver.

The encryption unit 22 performs a self-test on itself in response to input of power supply to the MFP 1 (that is, transition of power supply to the MFP 1 from an OFF state to an ON state) (F301). Alternatively, in F301, the encryption unit 22 performs a self-test on itself in response to detection by a sensor of a connection of the HDD 23 to the MFP 1. The self-test to be performed may include a “test using a known solution on encryption/decryption function”, a “test using a known solution on a random number generation function”, a “test using a known solution on a hash calculation function”, and an “alteration detection test with a checksum in a firmware area”, for example.

The “test using a known solution on encryption/decryption function” checks whether a value calculated by an algorithm for the encryption/decryption function with respect to an input feed is matched with the known solution for the encryption/decryption function prestored in the ROM 102 or not. If they are matched, the “test using a known solution on encryption/decryption function” produces a result which indicates success of the encryption. If not, the “test using a known solution on encryption/decryption function” produces a result which indicates failure of the encryption.

The “test using a known solution on a random number generation function” checks whether a value calculated by an algorithm for the random number generation function with respect to an input feed is matched with the known solution on the random number generation function prestored in the ROM 102 or not. If they are matched, the “test using a known solution on a random number generation function” produces a result which indicates success of the encryption. If not, the “test using a known solution on a random number generation function” produces a result which indicates failure of the encryption.

The “test using a known solution on a hash calculation function” checks whether a value calculated by an algorithm for the hash calculation function with respect to an input feed is matched with the known solution on the hash calculation function prestored in the ROM 102 or not. If they are matched, the “test using a known solution on a hash calculation function” produces a result which indicates success of the encryption. If not, the “test using a known solution on a hash calculation function” produces a result which indicates failure of the encryption.

The “alteration detection test with a checksum in a firmware area” checks whether a checksum value calculated for a binary file in a firmware area is matched with a checksum value prestored in the ROM 102 or not. If they are matched, the “alteration detection test with a checksum in a firmware area” produces a result which indicates success of the encryption. If not, the “alteration detection test with a checksum in a firmware area” produces a result which indicates failure of the encryption.

In a case where at least one of the plurality of tests in the self-test on the encryption unit 22 produces a result which indicates failure of the encryption, the encryption unit 22 determines that the self-test has detected an error in the encryption process. For example, in a case where a firmware program externally using the encryption unit 22 is tampered with, running the “alteration detection test with a checksum in the firmware area” produces a result which indicates failure of the encryption, from which it is determined that an error in the encryption process exists.

If it is detected that an error exists in the encryption process on the basis of the self-test, the encryption unit 22 stores, in the NVRAM 104, information describing that the self-test has detected an error in the encryption process (F302).

If it is detected that an error exists in the encryption process on the basis of the self-test, the encryption unit 22 responds with an error to a command to the HDD 23 received from the HDD controller 21 after the detection of the error. If it is detected that an error exists in the encryption process on the basis of the self-test, the encryption unit 22 may receive a command from the HDD controller 21 after that. This command may include a command for mutual authentication between the HDD controller 21 and the encryption unit 22, a command to acquire a state of the encryption unit 22, a command regarding mirroring of the HDD 23, and a command to the HDD 23, for example. Among these commands to the encryption unit 22, the encryption unit 22 responds to the command for acquiring a state of the encryption unit 22 and transmits encryption unit information including a result of a self-test regarding the encryption function of the encryption unit. The encryption unit information including a result of a self-test may be information regarding a state of the encryption unit 22 including a result of a self-test in the encryption unit 22 or information regarding mirroring of the HDD 23, for example.

If the presence of the HDD controller 21 is confirmed, the HDD driver must check whether the HDD 23 is connected through the HDD controller 21 or not. In order to do so, the HDD driver requests the HDD controller 21 to acquire basic information (including the storage capacity, the model and the used time) regarding the HDD 23 (F303). The HDD controller 21 receives the HDD information acquisition request from the HDD driver and transfers the HDD information acquisition request to the encryption unit (F303). The encryption unit 22 receives the HDD information acquisition request from the HDD controller 21.

On the other hand, if the encryption unit 22 detects, from the self-test, that an error has occurred in the encryption process, there is a possibility that the data stored in the HDD was not correctly encrypted by the encryption unit. In a case where the data stored in the HDD was not correctly encrypted and if the data stored in the HDD may be exploited by a third party, there is a risk that the data stored in the HDD may be accessed without permission. In order to avoid such a risk, the encryption unit blocks an acquisition request for the data stored in the HDD in response to receiving an indication, as a result of running a self-test on the encryption unit, indicating a failure in the encryption process. Thus, in this situation, the encryption unit 22 returns an error to the HDD controller 21 in response to the HDD information acquisition request (F304). The HDD controller 21 receives the error returned from the encryption unit 22 and transfers the returned error to the HDD driver (F304).

Next, the HDD driver requests the HDD controller 21 to acquire encryption unit information including the result of the self-test (F305). The HDD controller 21 receives the acquisition request for the encryption unit information from the HDD driver and transfers the acquisition request for the encryption unit information to the encryption unit 22 (F305).

The encryption unit 22 refers to the result of the self-test which is held in the NVRAM 104 and transmits the encryption unit information (including information that the result of the self-test of the encryption unit 22 is an error) to the HDD controller 21 (F306). The HDD controller 21 receives the encryption unit information (including information that the result of the self-test of the encryption unit 22 indicates an error in the encryption process) from the encryption unit 22 and transfers the received encryption unit information to the HDD driver (F306).

The HDD driver stores the encryption unit information (including information that the result of the self-test of the encryption unit 22 indicates an error in the encryption process) received from the HDD controller 21 in the nonvolatile memory 20 or the RAM 15 (F307).

The HDD driver then recognizes the internal state as a “state that the HDD 23 is not connected to the MFP 1” after the encryption unit information is stored in the nonvolatile memory 20 or the RAM 15 (F308). In other words, the HDD driver blocks a request to the HDD controller 21 after the encryption unit information is stored in the nonvolatile memory 20 or the RAM 15. This is because the CPU 13 cannot determine whether the HDD 23 connected to the MFP 1 is available or not when the basic information (including the storage capacity, the model and the used time) of the HDD 23 connected to the MFP 1 cannot be acquired.

When an error in the encryption process is indicated by a self-test performed on the encryption unit 22, the MFP 1 recognize that the HDD 23 is not connected to the MFP 1. Thus, after that, acquisition requests for information regarding the HDD 23 or information regarding the encryption unit 22 are not issued, as described above. In other words, when an error in the encryption process is indicated by a self-test on the encryption unit 22, the MFP 1 permits to acquire information regarding the HDD 23 from the HDD 23 or to acquire information regarding the encryption unit 22 from the encryption unit 22. On the other hand, when an error in the encryption process is indicated by a self-test on the encryption unit 22, the MFP 1 inhibits acquisition of information regarding the HDD 23 from the HDD 23 or acquisition of information regarding the encryption unit 22 from the encryption unit 22.

According to the first embodiment, in a case where an error in the encryption process is indicated by a self-test performed on the encryption unit 22 and the HDD driver cannot acquire basic information (including the storage capacity, the model and the used time) of the HDD 23, a mechanism is provided which notifies that an error in the encryption process is indicated by the self-test on the encryption unit 22. More specifically, before the encryption unit 22 blocks a request to the HDD controller 21 after an error in the encryption process is indicated by the self-test, the encryption driver requests to acquire encryption unit information to the HDD controller 21. After the encryption unit information is acquired from the HDD controller 21 and the acquired encryption unit information is stored in the nonvolatile memory 20 or the RAM 15, the HDD driver does not issue an acquisition request for information regarding the HDD 23 or information regarding the encryption unit 22. Details thereof will be described below.

The encryption driver requests the HDD driver to acquire encryption unit information in response to recognition of the “state that the HDD 23 is not connected to MFP 1” (F309). The HDD driver then acquires the encryption unit information stored in the nonvolatile memory 20 or the RAM 15 in response to receipt of the acquisition request for the encryption unit information from the encryption driver (F310). Next, the HDD driver transfers the encryption unit information acquired in F310 to the encryption driver (F311).

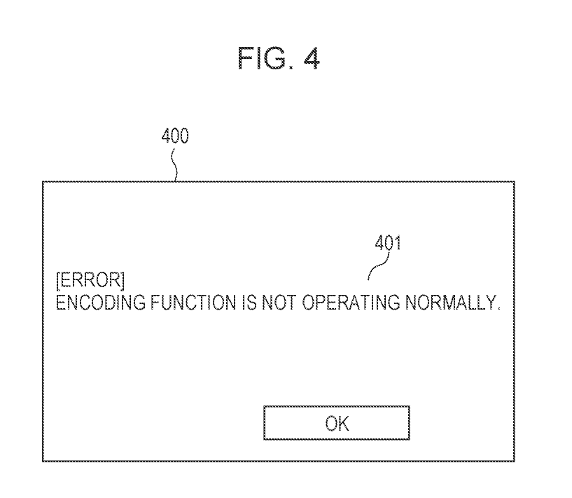

The CPU 101 determines whether or not the information regarding the encryption unit, which is received from the HDD driver, includes information that a result of a self-test on the encryption unit 22 indicates an error in the encryption process in the encryption unit 22. Because the result of the self-test on the encryption unit 22 indicates an error in the encryption process, the CPU 101 then displays a message 401 on the display unit in the operation unit 24 through an error screen 400 illustrated in FIG. 4 (F312).

In other words, in a case where an error in the encryption process is indicated by a self-test on the encryption unit 22, the fact that the encryption unit 22 has an error is notified to a user in response to powering on of the MFP 1 (or in response to transition of power supply to the MFP 1 from an OFF state to an ON state). Alternatively, in a case where an error in the encryption process is indicated by a self-test on the encryption unit 22, the fact that the encryption unit 22 has an error is notified to a user in response to detection by a sensor that the HDD 23 has been connected to the MFP 1.

If a user can recognize from the message 401 that the encryption unit 22 has an error because a result of a self-test on the encryption unit 22 results in an indication of an error in the encryption process, the message 401 may be a message “the encryption function is not normally operating” or a message “the self-test on the encryption function has failed” or may be an error code corresponding thereto. The presentation form of the message 401 is not limited to display on the display unit in the operation unit 24 as in the example above but may be, for example, display on a display unit in an external apparatus such as a PC connected to the MFP 1 over a network such as a LAN. If a user can recognize that a result of a self-test on the encryption unit 22 indicates an error in the encryption process, the presentation form of the message 401 is not limited to display on a display unit as in the example above but may be audio or optical notification to a user.

A user (such as a service engineer) may read the message 401 displayed on the display unit in the operation unit 24 and thus recognize that the encryption function installed in the MFP 1 has an error. A user recognizing that the encryption function installed in the MFP 1 has an error may replace the encryption unit 22 having an error in its encryption function by a new encryption unit 22 which does not have an error in the encryption function and connect the new encryption unit 22 to the HDD controller 21 and the HDD 23. In a case where the encryption unit 22 and the HDD controller 21 are mounted on one substrate, a user may replace the substrate having thereon the encryption unit 22 and the HDD controller 21 by a new substrate without an error in its encryption function thereon and connect the new substrate to the HDD 23. When data accesses to the HDD 23 are not allowed, a user may recognize that the encryption function of the encryption unit 22 connected to the HDD 23 has an error from a notification that a result of a self-test on the encryption unit 22 indicates an error in the encryption process. Thus, when data accesses to the HDD 23 are not allowed, a user may determine to replace the encryption unit 22 instead of replacement of the HDD 23.

According to the first embodiment, as described above, the processing in F305 to F307 in FIG. 3 is performed so that the encryption driver can be notified that a self-test on the encryption unit 22 has resulted in an indication of failure in the encryption process without requiring a dedicated signal line between the encryption unit 22 and the HDD controller 21. Thus, when a test on the encryption device results in an indication of failure, a user can recognize that data stored in a storage device cannot be acquired because the encryption device has an error.

### Second Embodiment

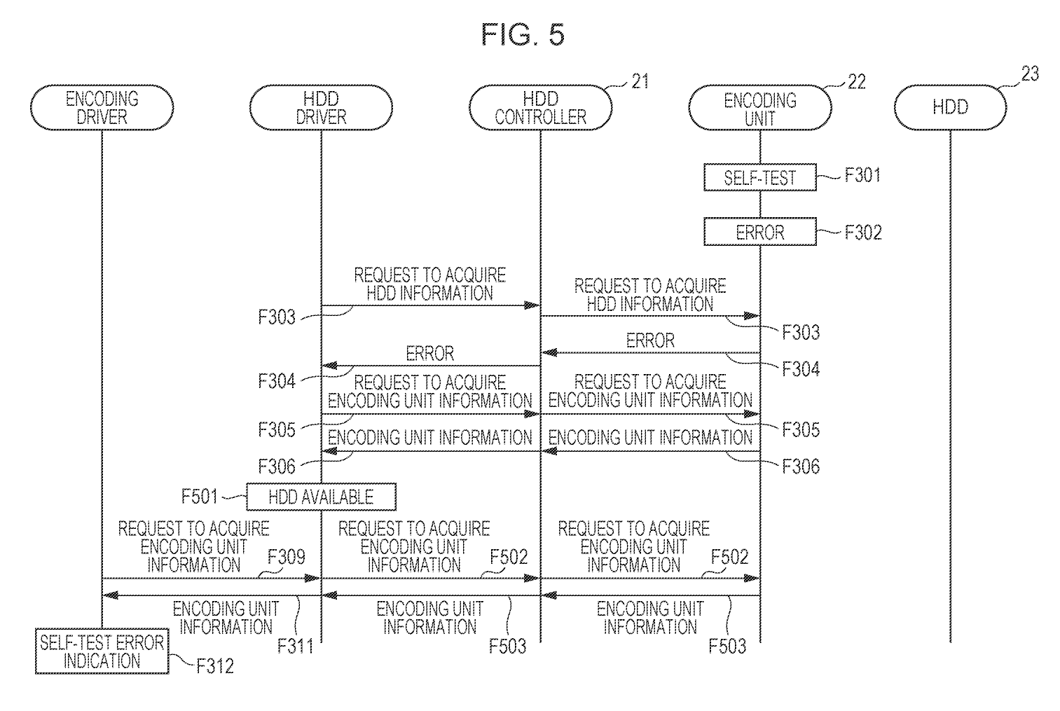

According to a second embodiment, even when a result of a self-test on the encryption unit 22 indicates an error in the encryption process, an HDD driver may recognize an internal state as a “state that the HDD 23 is connected to the MFP 1”. Thus, in a variation example according to the second embodiment, even when a result of a self-test of the encryption unit 22 indicates an error in the encryption process, the encryption driver can acquire encryption unit information (including the result of the self-test on the encryption unit 22) from the encryption unit 22. Because the second embodiment is different from the first embodiment in partial processing, the processing different from that of the first embodiment will mainly be described with reference to FIG. 5.

Because flows in F301 to F306, F309, F311, and F312 in FIG. 5 are identical to the flows in F301 to F306, F309, F311, and F312 in FIG. 3, any repetitive detail description will be omitted.

The HDD driver receives encryption unit information (including information that a result of a self-test on the encryption unit 22 indicates an error in the encryption process) from the HDD controller 21 in F306. After that, the HDD driver determines whether the result of the self-test on the encryption unit 22 indicates an error in the encryption process or not. On the basis of the determination that the result of the self-test on the encryption unit 22 indicates an error in the encryption process, the HDD driver recognizes the internal state as a “state that the HDD 23 is connected to the MFP 1” (F501). In this case, the HDD driver recognizes the internal state as a “state that the HDD 23 is connected to the MFP 1” but is not permitted to access actual data (such as a user database, a document database, and a held job) stored in the HDD 23.

When a self-test on the encryption unit 22 indicates a failure of the encryption process, there is a possibility that data stored in the HDD 23 was not correctly encrypted by the encryption unit 22. In a case where data stored in the HDD 23 was not encrypted correctly, when the data stored in the HDD 23 may be exploited by a third party, there is a risk that the data stored in the HDD 23 may be accessed without permission. In order to avoid such a risk, the encryption unit 22 may block an acquisition request for the actual data (such as a user database, a document database, and a held job) stored in the HDD 23 on the basis of a result of running the self-test on the encryption unit 22 indicating a failure of the encryption process.

On the other hand, the encryption driver can acquire the encryption unit information because the HDD driver recognizes the “state that the HDD 23 is connected to the MFP 1”.

The encryption driver requests the HDD driver to acquire the encryption unit information (F309). The HDD driver then receives the acquisition request for the encryption unit information from the encryption driver and transfers the acquisition request for the encryption unit information to the HDD controller 21 (F502). The HDD controller 21 then receives the acquisition request for the encryption unit information from the HDD driver and transfers the acquisition request for the encryption unit information to the encryption unit 22 (F502).

The encryption unit 22 then receives the acquisition request for the encryption unit information from the HDD controller 21. After that, the encryption unit 22 refers to the result of the self-test, which is held in the NVRAM 104, and transmits the encryption unit information (including information that the result of the self-test of the encryption unit 22 indicates an error in the encryption process) to the HDD controller 21 (F503). The HDD controller 21 then receives the encryption unit information transmitted from the encryption unit 22 and transfers the received encryption unit information to the HDD driver (F503).

The HDD driver then receives the encryption unit information (including information that the result of the self-test of the encryption unit 22 indicates an error in the encryption process) from the HDD controller 21 and transfers the received encryption unit information to the encryption driver (F311).

The CPU 101 determines whether or not the information regarding the encryption unit, which is received from the HDD driver, includes information that a result of a self-test on the encryption unit 22 indicates an error in the encryption process as a result of the self-test on the encryption unit 22. Because the result of the self-test on the encryption unit 22 indicates an error in the encryption process, the CPU 101 then displays a message 401 on the display unit in the operation unit 24 through an error screen 400 illustrated in FIG. 4 (F312).

According to the second embodiment, as described above, the processing in F501 to F503 in FIG. 5 is performed so that the encryption driver can be notified that a self-test on the encryption unit 22 has resulted in an indication of failure in the encryption process without requiring a dedicated signal line between the encryption unit 22 and the HDD controller 21. Thus, when a test on the encryption device indicates an error in the encryption process, a user can recognize that data stored in a storage device cannot be acquired because the encryption device is not operating properly.

### Third Embodiment

In a variation example according to a third embodiment, when a result of a self-test on the encryption unit 22 indicates an error in the encryption process, an HDD driver is allowed to acquire basic information regarding the HDD 23 though the HDD driver is not allowed to acquire actual data stored in the HDD 23.

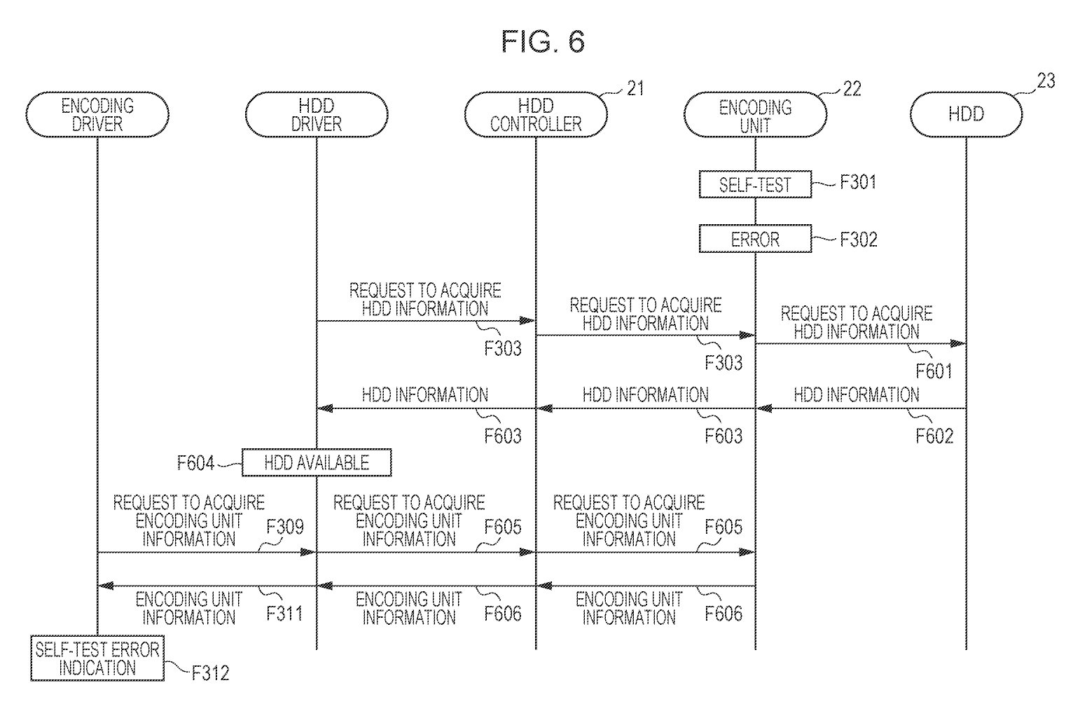

Because the third embodiment is different from the first embodiment in partial processing, the processing different from that of the first embodiment will mainly be described with reference to FIG. 6. Because flows in F301 to F303, F309, F311, and F312 illustrated in FIG. 6 are identical to the flows in F301 to F303, F309, F311, and F312 illustrated in FIG. 3, any repetitive detail description will be omitted.

The encryption unit 22 receives an acquisition request for basic information (including the storage capacity, the model and the used time) regarding the HDD 23 from the HDD controller 21 (F303) and transfers the acquisition request for the basic information (including the storage capacity, the model and the used time) regarding the HDD 23 to the HDD 23 (F601). The encryption unit 22 then acquires the basic information (including the storage capacity, the model and the used time) regarding the HDD 23 from the HDD 23 (F602) and transfers the acquired basic information (including the storage capacity, the model and the used time) regarding the HDD 23 to the HDD controller 21 (F603). The HDD controller 21 receives the basic information (including the storage capacity, the model and the used time) regarding the HDD 23 from the encryption unit 22 and transfers the basic information (including the storage capacity, the model and the used time) regarding the HDD 23 to the HDD driver (F603).

The HDD driver then acquires the basic information (including the storage capacity, the model and the used time) regarding the HDD 23. Then, upon booting of the MFP 1 or connection of the HDD 23, the CPU 13 determines whether the HDD 23 connected to the MFP 1 is available or not on the basis of the basic information (including the storage capacity, the model and the used time) regarding the HDD 23, which is acquired by the HDD driver. If the CPU 13 determines that the HDD 23 connected to the MFP 1 is available, a setting is defined such that data access to the HDD 23 can be allowed. Thus, the HDD driver recognizes the internal state as a “state that the HDD 23 is connected to the MFP 1” (F604). Thus, the encryption driver can acquire encryption unit information (such as a state of the encryption unit 22 including a result of a self-test on the encryption unit 22 and information regarding mirroring of the HDD 23).

The encryption driver requests the HDD driver to acquire the encryption unit information (F309). The HDD driver then receives the acquisition request for the encryption unit information from the encryption driver and transfers the acquisition request for the encryption unit information to the HDD controller 21 (F605). The HDD controller 21 then receives the acquisition request for the encryption unit information from the HDD driver and transfers the acquisition request for the encryption unit information to the encryption unit 22 (F605).

The encryption unit 22 then receives the acquisition request for the encryption unit information from the HDD controller 21. After that, the encryption unit 22 refers to the result of the self-test, which is held in the NVRAM 104, and transmits the encryption unit information to the HDD controller 21 (F606). The HDD controller 21 then receives the encryption unit information transmitted from the encryption unit 22 and transfers the received encryption unit information to the HDD driver (F606).

The HDD driver then receives the encryption unit information from the HDD controller 21 and transfers the received encryption unit information to the encryption driver (F311).

The CPU 101 determines whether or not the encryption unit information received from the HDD driver includes information describing that the result of the self-test on the encryption unit 22 indicates an error in the encryption process in the encryption unit 22. Because the result of the self-test on the encryption unit 22 indicates an error in the encryption process, the CPU 101 then displays a message 401 on the display unit in the operation unit 24 through an error screen 400 illustrated in FIG. 4 (F312).

According to the third embodiment, as described above, the processing in F601 to F606 in FIG. 6 is performed so that the encryption driver can be notified that a self-test on the encryption unit 22 has produced a result indicating a failure in the encryption process without requiring a dedicated signal line between the encryption unit 22 and the HDD controller 21. Thus, when a test on the encryption device indicates an error in the encryption process, a user can recognize that data stored in a storage device cannot be acquired because the encryption device is not operating properly.

### Fourth Embodiment

In a variation example according to a fourth embodiment, when a result of a self-test on the encryption unit 22 indicates an error in the encryption process, the encryption unit 22 does not return an error to the HDD controller 21 in response to an HDD information acquisition request. The encryption unit 22 is configured to return HDD information containing encryption unit information instead of return of an error to the HDD controller 21.

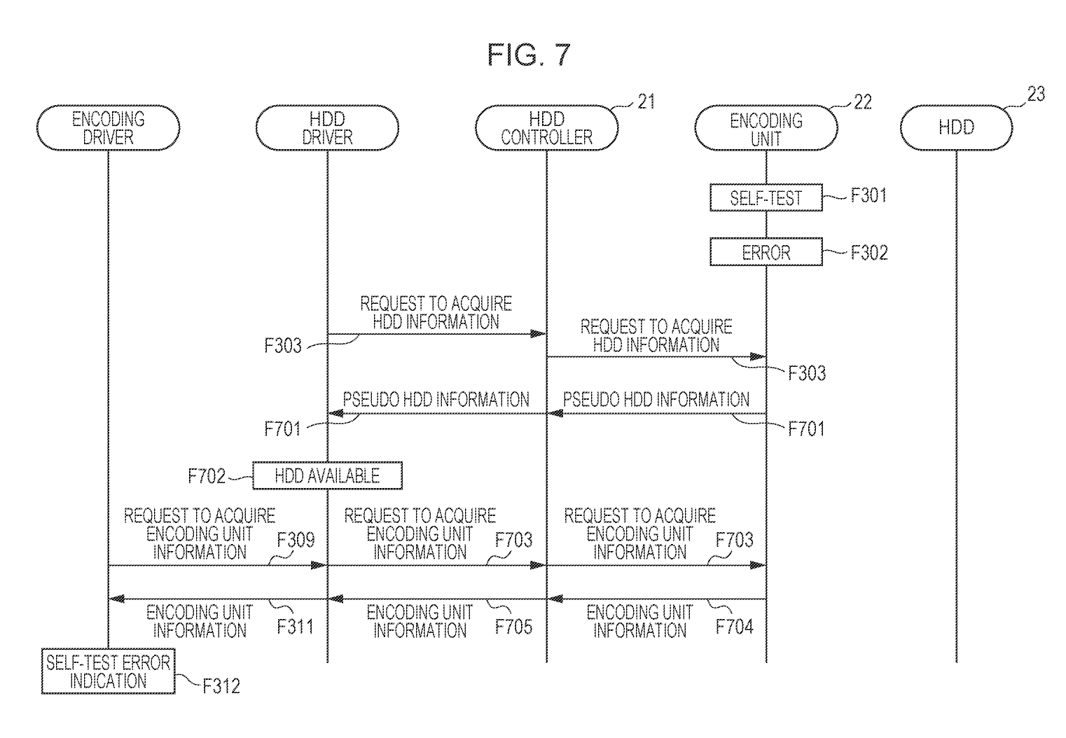

Because the fourth embodiments different from the first embodiment in partial processing, the processing different from that of the first embodiment will mainly be described with reference to FIG. 7.

Because flows in F301 to F303, F309, F311, and F312 illustrated in FIG. 7 are identical to the flows in F301 to F303, F309, F311, and F312 illustrated in FIG. 3, any repetitive detail description will be omitted.

The encryption unit 22 receives an acquisition request for basic information (including the storage capacity, the model and the used time) regarding the HDD 23 from the HDD controller 21 (F303). The encryption unit 22 then generates HDD information containing encryption unit information (hereinafter, called pseudo HDD information) instead of the basic information (including the storage capacity, the model and the used time) regarding the HDD 23. The encryption unit information may include a state of the encryption unit 22 including a result of a self-test on the encryption unit 22 and information regarding mirroring of the HDD 23, for example. In order to generate such pseudo HDD information, the encryption unit 22 refers to a result of a self-test held in the NVRAM 104 and acquires encryption unit information (including information describing that the result of the self-test on the encryption unit 22 is an error). Thus, the pseudo HDD information includes information that the result of the self-test on the encryption unit 22 is an error.

The encryption unit 22 returns the pseudo HDD information to the HDD controller 21 (F701). The encryption unit 22 receives the pseudo HDD information from the encryption unit 22 and transfers the pseudo HDD information to the HDD driver (F701).

The HDD driver determines whether the result of the self-test on the encryption unit 22 is an error or not. The HDD driver extracts the result of the self-test on the encryption unit 22 from the encryption unit information included in the pseudo HDD information and determines whether the result of the self-test on the encryption unit 22 is an error or not. On the basis of the determination that the result of the self-test on the encryption unit 22 is an error, the HDD driver recognizes the internal state as a “state that the HDD 23 is connected to the MFP 1” (F702). In this case, the HDD driver recognizes the “state that the HDD 23 is connected to the MFP 1”, the encryption driver can acquire the encryption unit information.

The encryption driver requests the HDD driver to acquire the encryption unit information (F309). The HDD driver then receives the acquisition request for the encryption unit information from the encryption driver and transfers the acquisition request for the encryption unit information to the HDD controller 21 (F703). The HDD controller 21 then receives the acquisition request for the encryption unit information from the HDD driver and transfers the acquisition request for the encryption unit information from the encryption unit 22 (F703).

The encryption unit 22 then receives the acquisition request for the encryption unit information from the HDD controller 21. After that, the encryption unit 22 refers to the result of the self-test, which is held in the NVRAM 104 and transmits the encryption unit information (including information describing that the result of the self-test on the encryption unit 22 indicates an error in the encryption process) to the HDD controller 21 (F704). The HDD controller 21 then receives the encryption unit information transmitted from the encryption unit 22 and transfers the received encryption unit information to the HDD driver (F704).

The HDD driver then receives the encryption unit information (including information describing that the result of the self-test on the encryption unit 22 indicates an error in the encryption process) from the HDD controller 21 and transfers the received encryption unit information to the encryption driver (F311).

The CPU 101 then determines whether or not the information regarding the encryption unit received from the HDD driver includes information describing that the result of the self-test on the encryption unit 22 indicates an error in the encryption process. Because the result of the self-test on the encryption unit 22 indicates an error in the encryption process, the CPU 101 then displays a message 401 on the display unit in the operation unit 24 through an error screen 400 illustrated in FIG. 4 (F312).

According to the fourth embodiment, as described above, the processing in F701 to F705 in FIG. 7 is performed so that the encryption driver can be notified that a self-test on the encryption unit 22 has produced a result indicating a failure in the encryption process without requiring a dedicated signal line between the encryption unit 22 and the HDD controller 21. Thus, when a test on the encryption device indicates an error in the encryption process, a user can recognize that data stored in a storage device cannot be acquired because the encryption device has an error.

It should be understood that the aforementioned embodiments do not limit the claims. Rather, various changes (including organic combinations of the embodiments) can be made without departing from the spirit of the present disclosure and are not excluded from the scope of the present disclosure.

For example, according to the embodiments, the MFP 1 including the scanner device 2 and the printer device 4 has been described as a data processing device. Embodiments of the present invention are not limited thereto. To illustrate, the controls as described above may also be applied to an image input device that includes the scanner device 2 but does not include the printer device 4, for example, as the data processing device. The controls may also be applicable to an image output device including the printer device 4 but not including the scanner device 2 as the data processing device.

For example, according to various embodiments, the CPU 13 in the controller unit 3 in the MFP 1 is a subject of the controls described in this disclosure. However, embodiments of the present disclosure are not limited thereto. Other embodiments may be configured such that a part or all of the controls may be executable by a print control device such as an external controller in a housing separate from the MFP 1.

### Other Embodiments

Various embodiment can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, it is to be understood that the scope of the following claims is to be accorded the broadest interpretation so as to encompass all such modifications and equivalent structures and functions.

This application claims the benefit of Japanese Patent Application No. 2016-030171 filed Feb. 19, 2016, which is hereby incorporated by reference herein in its entirety.

What is claimed is:

1. A data processing device comprising:
a storage that stores data;
an encryption unit that encrypts data to be stored in the storage;
a memory that stores a set of instructions; and
at least one processor that executes the instructions to:
acquire information stored in the storage via the encryption unit;
perform control so as to acquire the information stored in the storage in a case where a test performed by the encryption unit produces a result indicating a failure in an encryption process;
hold the result of the test performed by the encryption unit in a holding unit in a case where the test performed by the encryption unit produces the result indicating a failure in an encryption process; and
notify information that the test performed by the encryption unit indicates a failure in an encryption process on the basis of the result of the test performed by the encryption unit.

2. The data processing device according to claim 1, wherein the at least one processor executes instructions stored in the memory to:
notify the information that the test performed by the encryption unit indicates a failure in an encryption process in response to transition of a power supply to the data processing device from an OFF state to an ON state.

3. The data processing device according to claim 1, wherein the at least one processor executes instructions stored in the memory to:
notify information that the test performed by the encryption unit indicates a failure in an encryption process in response to connection of the storage to the data processing device.

4. The data processing device according to claim 1, wherein the at least one processor executes instructions stored in the memory to:
perform control so as to transmit an acquisition request for information stored in the storage to the storage in a case where the test performed by the encryption unit indicates a failure in an encryption process; and
perform control so as not to transmit an acquisition request for information in the storage to the storage in a case where the test performed by the encryption unit indicates a failure in an encryption process.

5. The data processing device according to claim 1, wherein the at least one processor executes instructions stored in the memory to:
receive an acquisition request for information in the storage from the storage; and
hold the result of the test performed by the encryption unit in the holding unit in a case where the test performed by the encryption unit indicates a failure in an encryption process and, in response to the acquisition request, notify information that the test performed by the encryption unit indicates a failure in an encryption process on the basis of the result of the test performed by the encryption unit.

6. The data processing device according to claim 1, wherein the test performed by the encryption unit is performed in response to transition of power supply to the data processing device from an OFF state to an ON state.

7. The data processing device according to claim 1, wherein the test performed by the encryption unit is performed in response to connection of the storage to the data processing device.

8. The data processing device according to claim 1, wherein the test performed by the encryption unit includes at least one of a test on an encryption/decryption function, a test on a random number generation function, a test on a hash calculation function, and a test on alteration detection in a firmware area.

9. The data processing device according to claim 1, wherein information stored in the storage includes at least one of a storage capacity of the storage, a model of the storage, and a used time of the storage.

10. A data processing device comprising:
a storage that stores data;
a memory device that stores a set of instructions; and
at least one processor that executes the instructions to:
encrypt data to be stored in the storage using an encrypting function;
acquire the information stored in the storage from the storage;
perform control so as to acquire the information in the storage from the storage in a case where a test regarding the encrypting function indicates a failure in the encryption function;
hold the result of the test in a holding unit in a case where the test indicates a failure in the encryption function; and
notify information that the test indicates a failure in an encryption process on the basis of the result of the test.

11. A control method for a data processing device, the method comprising:
encrypting data to be stored in a storage using an encrypting function;
acquiring information stored in the storage from the storage;
performing control so as to acquire the information stored in the storage from the storage in a case where a test regarding the encrypting function;
holding a result of the test in a holding unit in a case where the test regarding the encrypting function indicates a failure in an encryption process; and
notifying information that the test indicates a failure in an encryption process on the basis of the result of the test.

12. A non-transitory computer readable storage medium storing a program for causing a processor to execute a method of controlling a data processing device, the method comprising:
performing control for encrypting data to be stored in a storage using an encrypting function;
acquiring information stored in the storage from the storage;
performing control so as to acquire the information stored in the storage from the storage in a case where a test regarding the encrypting function indicates a failure in an encryption process;
holding a result of the test in a holding unit in a case where the test indicates a failure in an encryption process; and
notifying information that the test indicates a failure in an encryption process on the basis of the result of the test.
